(19) United States
(12) Patent Application Publication
(10) Pub. No.: US 2007/0013676 A1
(43) Pub. Date: Jan. 18, 2007

(54) Display apparatus

(76) Inventor: Kijuro Obata, Iwaki-city (JP)

Correspondence Address: BRINKS HOFER GILSON & LIONE, P.O. BOX 10395, CHICAGO, IL, 60610, US

(21) Appl. No.: 11/479,960

(22) Filed: Jun. 29, 2006

(30) Foreign Application Priority Data
Jul. 1, 2005 (JP) 2005-193556

(51) Int. Cl. G09G 5/00

(52) U.S. Cl. 345/173

(57) ABSTRACT

A display apparatus such as a dual-view display includes a display control unit for controlling, in accordance with a priority of an image corresponding to particular contents, the display of the images of the other contents so that the operation of a touch-panel control screen for the other contents is disabled.

### BACKGROUND OF THE INVENTION

1. Field of the Invention

The present invention generally relates to a display apparatus and, in particular, to a display apparatus that is suitable for simultaneously displaying a plurality of images of corresponding contents, each image being visible to the exclusion of the others when the screen of the display apparatus is viewed from particular angles.

2. Description of the Related Art

In recent years, for use in a display apparatus of a navigation system, a dual-view display has been developed that has one display screen, but is capable of displaying different images at the same time in accordance with the viewing angles (refer to, for example, Japanese Unexamined Patent Application Publication No. 2004-233816).

Such a dual-view display can provide a plurality of different contents (such as navigation information, DVD (digital versatile disc) content, and a television program) at the same time. For example, when the dual-view display is mounted in an in-vehicle navigation system, an operator sitting in a driver seat (a driver) can view navigation information on a screen in the viewing direction from the driver seat as information viewable from that viewing direction. On the other hand, an operator sitting in a front passenger seat can view, for example, an image from a DVD or a title input screen of a music CD (compact disc) on the screen in the viewing direction from the front passenger seat.

Conventionally, on a screen of a dual-view display, a touch-panel navigation control screen for setting a destination or a DVD control touch-panel screen for selecting a menu are displayed. An operator sitting in a driver seat or a front passenger seat touches such a control screen in order to operate the control touch-panel screen using their fingers.

Thus, in known dual-view displays, when an operator sitting in a front passenger seat operates the touch-panel control screen, the operator's fingers may prevent an operator sitting in the driver seat from performing an operation required for driving (e.g., an operation on a navigation touch-panel screen). Also, when the operator sitting in a front passenger seat operates the touch-panel control screen, the operator's fingers may prevent the operator sitting in the driver seat from viewing the information required for driving (e.g., navigation information including an enlarged image of an intersection and traffic information). For example, as shown in FIG. 7, the case in which a driver-side screen 2 of a dual-view display 1 displays a navigation image relating to slow traffic information (VICS-level 2) and a passenger-side screen 3 displays a CD title input screen that allows an input operation via a touch panel is discussed below.

In such a case, when the operator sitting in a front passenger seat enters a CD title, a finger of the operator sitting in the front passenger seat partially hides the image relating to the slow traffic information. Thus, the viewability of the image relating to the slow traffic information deteriorates. At that time, the display area of the CD title input screen and the display area of the image relating to the slow traffic information may be disposed on the right hand side and the left hand side, respectively, of the screen so that the fingers of the operator sitting in a front passenger seat do not hide the image of the slow traffic information. However, the size of the image of the slow traffic information becomes very small. Accordingly, the viewability of the image of the slow traffic information also deteriorates.

As noted above, in known dual-view displays, the use of content by one operator may be disturbed by the operation of a touch-panel control screen by the other operator.

### SUMMARY OF THE INVENTION

Accordingly, it is an object of the present invention to provide a display apparatus in which the use of content by one operator is not disturbed by the operation of a touch-panel control screen by the other operator.

According to the present invention, a display apparatus includes a display control unit for controlling, in accordance with a priority of the image corresponding to particular contents, the display of the images of the other contents so that the operation of a touch-panel control screen for the other contents is disabled.

Preferably, the display control unit controls the display of the images of the other contents so that the operation of the touch-panel control screen for the other contents is disabled while the touch-panel control screen for the particular contents is being operated.

For example, the display control unit controls the display of the images of the other contents so that the operation of the touch-panel control screen for the other contents is disabled while important information is being displayed as an image of the particular contents. Preferably, the display control unit controls the display of the images of the other contents so that the operation of the touch-panel control screen for the other contents is disabled while the touch-panel control screen for the particular contents is being operated or while important information is being displayed as an image of the particular contents.

In one aspect, in order to disable the operation of the touch-panel control screen for the other contents, the display control unit controls the display of the images of the other contents so that the touch-panel control screen for the other contents is not displayed.

Preferably, in order to disable the operation of the touch-panel control screen for the other contents, the display control unit controls the display of the images of the other contents so that a warning message indicating that the touch-panel control screen for the other contents is inoperable is displayed.

In another aspect, in order to disable the operation of the touch-panel control screen for the other contents, the display control unit controls the display of the images of the other contents so that the touch-panel control screen for the other contents is displayed in a light color.

Preferably, in order to disable the operation of the touch-panel control screen for the other contents, the display control unit controls the display of the images of the other contents so that a control screen that allows an input operation other than the operation of the touch-panel control screen is displayed.

Preferably, the particular contents is a content for an operator sitting in a driver seat and the other contents are contents for an operator sitting in a front passenger seat. In such a configuration, in accordance with a priority of the image corresponding to the content for an operator sitting in the driver seat, the display control unit can control the display of the images of the contents for an operator sitting in the front passenger seat so that the operation of the touch-panel control screen for the contents for the operator sitting in the front passenger seat is disabled.

The touch-panel control screen of the content for the operator sitting in a driver seat may be a navigation control screen. In such a configuration, the display control unit can control the display of the images of the contents for the operator sitting in a front passenger seat so that the operation of the touch-panel control screen for the contents for the operator sitting in the front passenger seat is disabled while the operator sitting in a driver seat is operating the navigation control screen.

In one aspect, the important information displayed as an image of the content for the operator sitting in a driver seat is important driving information. In such a configuration, the display control unit can control the display of the images of the contents for the operator sitting in a front passenger seat so that the operation of the touch-panel control screen for the contents for the operator sitting in the front passenger seat is disabled while the important driving information is displayed as an image of content for the operator sitting in a driver seat.

The important driving information may include an enlarged image of an intersection. In such a configuration, the display control unit can control the display of the images of the contents for the operator sitting in a front passenger seat so that the operation of the touch-panel control screen for the contents for the operator sitting in the front passenger seat is disabled while the enlarged image of an intersection is displayed as an image of content for the operator sitting in a driver seat.

The important driving information may include slow traffic information. In such a configuration, the display control unit can control the display of the images of the contents for the operator sitting in a front passenger seat so that the operation of the touch-panel control screen for the contents for the operator sitting in the front passenger seat is disabled while the slow traffic information is displayed as an image of content for the operator sitting in a driver seat.

Preferably, an interrupt signal is supplied to the display control unit in accordance with the priority of the image of the particular contents and, in response to the interrupt signal, the display control unit controls the display of the images of the other contents so that the operation of the touch-panel control screen for the other contents is disabled.

Preferably, the display control unit controls the display of the images of the other contents so that the operation of the touch-panel control screen for the other contents is disabled when receiving an input operation indicating that the image of the particular contents has the higher priority.

According to the display apparatus of the present invention, the use of content by one operator is not disturbed by the operation of a touch-panel control screen by the other operator. Additionally, to obtain such an advantage, a complicated operation in which the display apparatus determines which operator among a plurality of operators is operating the touch-panel control screen and disables the touch panel operation based on the determined operator is not required. Thus, the manufacturing cost can be greatly reduced.

Additionally, according to the display apparatus of the present invention, the operation of a touch-panel control screen by one operator when needed is not disturbed by the operation of a touch-panel control screen by the other operator. Furthermore, according to the display apparatus of the present invention, the viewability of important information provided to one operator is not impaired by the operation of the touch-panel control screen by the other operator.

In one aspect, according to the display apparatus of the present invention, when some content is used by one operator as needed, the touch-panel control screen is not displayed. Accordingly, simplified control can be provided in which the use of the content by one operator will not be disturbed by the operation of the touch-panel control screen by the other operator.

Furthermore, according to the display apparatus of the present invention, when some content is used by one operator as needed, a warning message indicating that the touch-panel control screen is inoperable can be displayed for the other operator.

In another aspect, according to the display apparatus of the present invention, when content is used by one operator as needed, the touch-panel control screen can be displayed in a light color so that the touch-panel control screen by the other operator is inoperable.

Furthermore, according to the display apparatus of the present invention, when content is used by one operator as needed, a control screen that allows an input operation other than the operation of the touch-panel control screen is displayed. Accordingly, simplified control can be provided in which the use of the content by one operator will not be disturbed by the operation of the touch-panel control screen by the other operator.

Additionally, according to the display apparatus of the present invention, the use of content by an operator sitting in a driver seat when needed is not disturbed by the operation of a touch-panel control screen by an operator sitting in a front passenger seat.

Furthermore, according to the display apparatus of the present invention, while an operator sitting in a driver seat is operating a navigation control screen required for driving when needed, this operation of the navigation control screen by the operator sitting in a driver seat will not be disturbed by the operation of the touch-panel control screen by an operator sitting in a front passenger seat.

Still furthermore, according to the display apparatus of the present invention, while important driving information is being provided to an operator sitting in a driver seat as needed, the viewability of the important driving information provided to the operator sitting in a driver seat is not impaired by the operation of the touch-panel control screen by an operator sitting in a front passenger seat.

Yet still furthermore, according to the display apparatus of the present invention, while an enlarged image of an intersection is being provided to an operator sitting in a driver seat as needed, the viewability of the enlarged image of an intersection provided to the operator sitting in a driver seat is not impaired by the operation of the touch-panel control screen by an operator sitting in a front passenger seat.

Yet still furthermore, according to the display apparatus of the present invention, while slow traffic information is being provided to an operator sitting in a driver seat as needed, the viewability of the slow traffic information provided to the operator sitting in a driver seat is not impaired by the operation of the touch-panel control screen by an operator sitting in a front passenger seat.

Yet still furthermore, according to the display apparatus of the present invention, by using an interrupt signal, simplified control can be provided in which the use of content by one operator will not be disturbed by the operation of the touch-panel control screen by the other operator.

Yet still furthermore, according to the display apparatus of the present invention, the intent of one operator can be better reflected so that the use of content by the operator will not be disturbed by the operation of the touch-panel control screen by the other operator.

### BRIEF DESCRIPTION OF THE DRAWINGS

FIG. 1 is a block diagram of a display apparatus according to an embodiment of the present invention;

FIG. 2 illustrates an example of combined image data in the display apparatus according to the embodiment of the present invention;

FIG. 3 illustrates an example of an image viewed from a driver seat side and an image viewed from a front passenger seat side while operating a navigation control screen of the display apparatus according to the embodiment of the present invention;

FIG. 4 illustrates an example of an image viewed from a driver seat side and an image viewed from a front passenger seat side while important driving information is being displayed on the display apparatus according to the embodiment of the present invention;

FIG. 5 illustrates another example of an image viewed from a driver seat side and an image viewed from a front passenger seat side during the operation of a navigation control screen of the display apparatus or while important driving information is being displayed on the display apparatus according to the embodiment of the present invention;

FIG. 6 illustrates another example of an image viewed from a driver seat side and an image viewed from a front passenger seat side during the operation of a navigation control screen of the display apparatus or while important driving information is being displayed on the display apparatus according to the embodiment of the present invention; and

FIG. 7 illustrates an example of an image viewed from a driver seat side and an image viewed from a front passenger seat side on a known dual-view display.

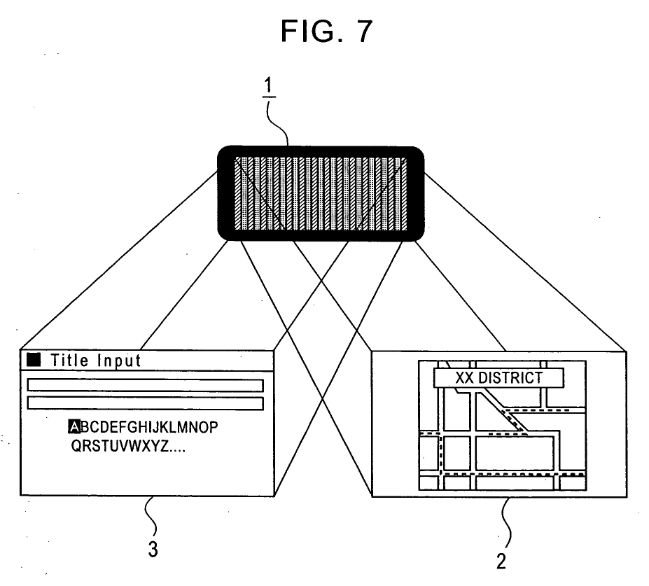

### DESCRIPTION OF THE PREFERRED EMBODIMENTS

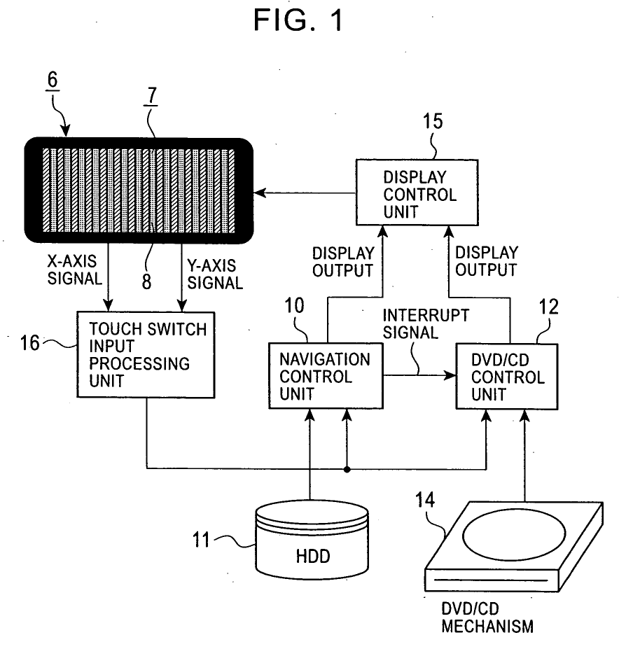

An exemplary display apparatus according to an embodiment of the present invention is now described with reference to FIGS. 1 through 6. According to the present embodiment, the display apparatus is used for a display of an in-vehicle navigation system.

According to the present embodiment, as shown in FIG. 1, a display apparatus 6 includes a display unit 7. The display apparatus 6 is a dual-view display that can simultaneously display two images of different contents in two different viewing directions when viewed from a driver seat side and from a front passenger seat side. A touch panel 8 is mounted on the front surface of the display unit 7 so that an operator can perform a variety of input operations by touching the display unit 7 using the operator's fingers.

As shown in FIG. 1, the display apparatus 6 includes a navigation control unit 10. The navigation control unit 10 generates and displays image data concerning vehicle navigation (hereinafter referred to as a “navigation image”), which corresponds to content for an operator sitting in a driver seat (hereinafter referred to as “content for a driver”).

A hard disk drive (HDD) 11 is connected to an input channel of the navigation control unit 10. The hard disk drive 11 stores map images, screens capable of receiving navigation operations entered using the touch panel 8 (such as an input operation of the destination), and image data (such as map data) required for generating a variety of navigation images (e.g., the slow traffic information and an enlarged intersection image). Hereinafter, the screens for receiving navigation operations are referred to as “navigation control screens” and the image data for navigation are referred to as “navigation image data”.

The navigation control unit 10 reads such data stored in the hard disk drive 11 to generate navigation image data. The navigation control unit 10 then outputs (displays) the generated navigation image data.

To generate the slow traffic information, road traffic information received from the vehicle information and communication system (VICS) center via a beacon receiver or an FM multiplex receiver (none are shown) is used.

Additionally, according to this embodiment, the display apparatus 6 includes a DVD/CD control unit 12. The DVD/CD control unit 12 outputs and displays data of a DVD image or a CD image, which is an image corresponding to content for an operator sitting in a front passenger seat (hereinafter referred to as “content for a front passenger”). A DVD image includes not only a main story but also a DVD control screen for allowing an operator to perform input operations via the touch panel 8. Similarly, a CD image includes a CD control screen for allowing an operator to perform an input operation via the touch panel 8.

A DVD/CD mechanism 14 is connected to an input channel of the DVD/CD control unit 12. A DVD or a CD, which is mounted in the DVD/CD mechanism 14, includes image data of the DVD image or the CD image, respectively. The DVD/CD control unit 12 reads image data (hereinafter referred to as “DVD/CD image data”) of the DVD image or the CD image (hereinafter referred to as a “DVD/CD image”) stored in the DVD or CD mounted in the DVD/CD mechanism 14. The DVD/CD control unit 12 then outputs and displays the image data.

A display control unit 15 is connected to the output channels of the navigation control unit 10 and the DVD/CD control unit 12, and is also connected to the input channel of the display unit 7. The navigation image data from the navigation control unit 10 and the DVD/CD image data from the DVD/CD control unit 12 are supplied to the display control unit 15.

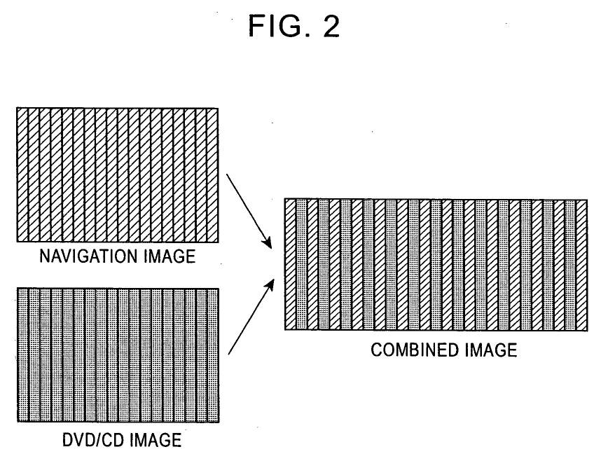

The display control unit 15 processes the received navigation image data and DVD/CD image data to generate a combined image for a dual-view display in which lines of the navigation image and lines of the DVD/CD image are alternately arranged, as shown in FIG. 2. The display control unit 15 then supplies the generated combined image to the display unit 7.

Thus, the combined image of the navigation image and the DVD/CD image is displayed on the screen of the display unit 7. When the combined image is viewed from the driver seat side, the driver-side screen 2 can show the navigation image. In contrast, when the combined image is viewed from the front passenger seat side, the passenger-side screen 3 can show the DVD/CD image.

A touch switch input processing unit 16 is connected to the output channel of the touch panel 8 of the display unit 7. An X-axis signal and a Y-axis signal are supplied to the touch switch input processing unit 16 as a detection signal of the touch panel 8.

The touch switch input processing unit 16 provides, to the navigation control unit 10 or the DVD/CD control unit 12, input operation signals corresponding to operations entered on the navigation control screen or operations entered on an operation screen of a DVD or a CD (hereinafter referred to as a “CD/DVD operation screen”) on the basis of the X-axis signal and Y-axis signal. The navigation control unit 10 and the DVD/CD control unit 12 generate image data for displaying a screen subsequent to the input screen of the touch panel 8 on the basis of the input operation signal received from the touch switch input processing unit 16.

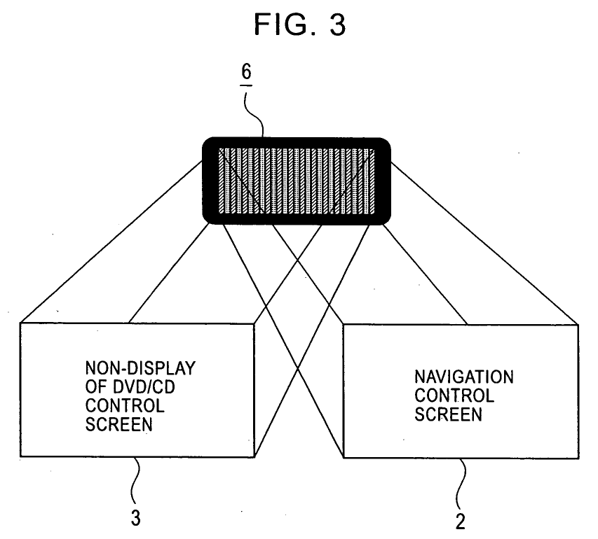

According to the present embodiment, in the display apparatus 6 having such a basic structure, the DVD/CD control unit 12 functions as a display control unit. That is, the DVD/CD control unit 12 controls the display of the DVD/CD image so that the operation of the CD/DVD control screen is disabled in accordance with the priority of a navigation image. More specifically, as shown in FIG. 3, the DVD/CD control unit 12 performs control so that the DVD/CD control screen corresponding to the passenger-side screen 3 is not displayed when the navigation image viewed on the driver-side screen 2 is the navigation control screen and the navigation control screen is operated via the touch panel 8.

As used herein, the time when the navigation control screen is operated refers to a period of time from the time when an operator sitting in a driver seat touches the navigation control screen to the time when the operator completes the series of operations.

The navigation control unit 10 sends an interrupt signal indicating that the navigation control screen is operated to the DVD/CD control unit 12 while the navigation control screen is being operated (during the operation). When triggered by the input of the interrupt signal from the navigation control unit 10, the DVD/CD control unit 12 performs control so that the DVD/CD control screen is not displayed.

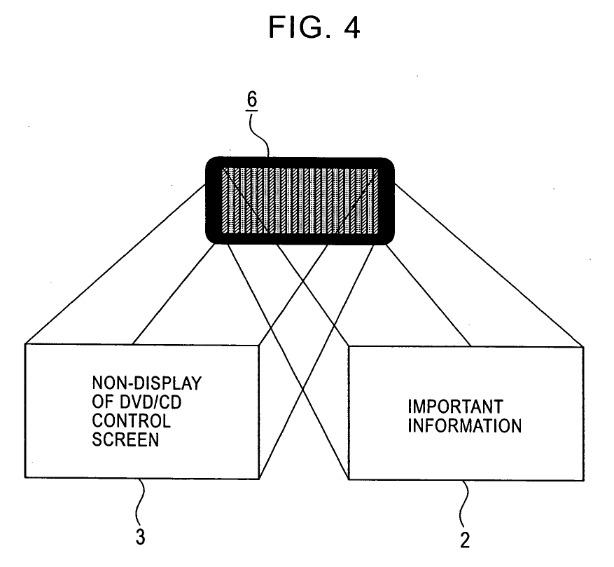

Additionally, as shown in FIG. 4, the DVD/CD control unit 12 performs control so that the DVD/CD control screen corresponding to the passenger-side screen 3 is not displayed when important driving information, such as an enlarged image of an intersection or slow traffic information, is displayed (during the display) as a navigation image displayed on the driver-side screen 2. The information indicating that the navigation image is important for driving is also sent to the DVD/CD control unit 12 using an interrupt signal sent from the navigation control unit 10 to the DVD/CD control unit 12. Therefore, according to this embodiment, the DVD/CD control unit 12 can perform control so that the DVD/CD control screen is not displayed while the navigation control screen is being operated or the important driving information is being displayed.

Thus, as shown in FIG. 3, since the DVD/CD control screen is not displayed while the navigation control screen is being operated, the operation of the navigation control screen by the operator sitting in the driver seat will not be prevented by the operation of the DVD/CD control screen by the operator sitting in the front passenger seat. Similarly, as shown in FIG. 4, since the DVD/CD control screen is not displayed while the important driving information is being displayed, the viewability of the important driving information is not impaired by the operation of the operator sitting in the front passenger seat.

Alternatively, to control the display of a DVD/CD image so that the above-described DVD/CD control screen is not operated, a control other than the control shown in FIGS. 3 and 4 may be carried out.

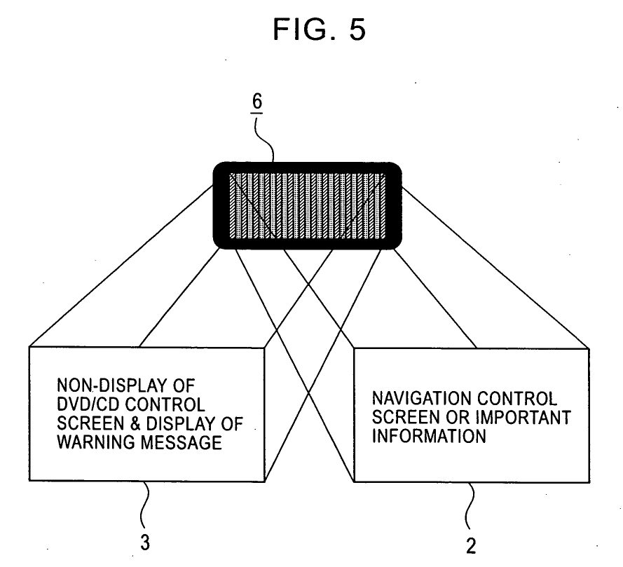

For example, as shown in FIG. 5, the DVD/CD control unit 12 and the navigation control unit 10 may perform control so that the DVD/CD control screen corresponding to the passenger-side screen 3 is not displayed while the navigation control screen is being operated or the important driving information is being displayed and, instead, a warning message indicating that the DVD/CD control screen is inoperable is displayed. Examples of the warning message include a message “The touch panel is inoperable while the driver is performing an operation. Use a remote control unit.” In such a case, a control screen that allows an operation other than the input operation via the touch panel 8 (e.g., input operation using a remote control unit) may be displayed.

According to the design illustrated in FIG. 5, while the navigation control screen is being operated or the important driving information is being displayed, an operator sitting in a front passenger seat can immediately know that the DVD/CD control screen is inoperable. Accordingly, the touching of the DVD/CD control screen by the operator sitting in the front passenger seat can be prevented. Thus, as in the cases shown in FIGS. 3 and 4, the operation of the navigation control screen by the operator sitting in the driver seat is not disturbed by the operation of the DVD/CD control screen by the operator sitting in the front passenger seat. Also, the viewability of the important driving information is not impaired by the operation of the DVD/CD control screen by the operator sitting in the front passenger seat.

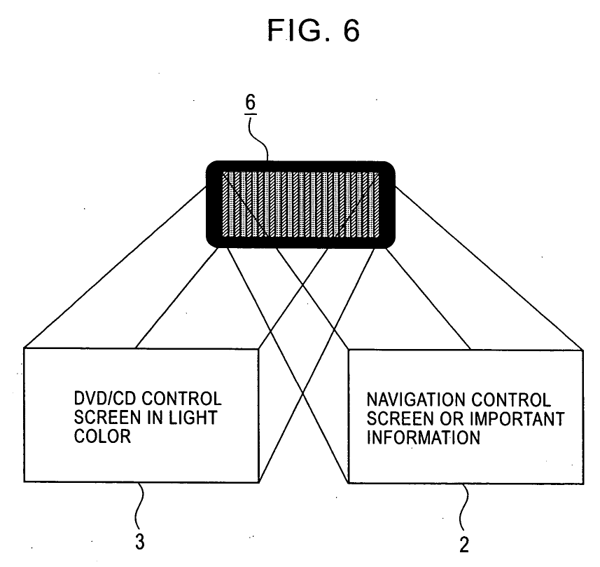

Furthermore, as shown in FIG. 6, the DVD/CD control unit 12 and the navigation control unit 10 may perform control so that the DVD/CD control screen is displayed in a light color in order to disable the operation of the DVD/CD control screen which corresponds to the passenger-side screen 3 while the navigation control screen is being operated or important driving information is being displayed. According to this design, while the navigation control screen is being operated or important driving information is being displayed, the operator sitting in a front passenger seat can immediately know that the DVD/CD control screen is inoperable, as in the case illustrated in FIG. 5.

Thus, as in the cases shown in FIGS. 3 to 5, the operation of the navigation control screen by the operator sitting in a driver seat is not disturbed by the operation of DVD/CD control screen by the operator sitting in the front passenger seat. In addition, the viewability of the important driving information is not impaired by the operation of the DVD/CD control screen by the operator sitting in the front passenger seat.

The operation of the present embodiment is described next.

In the present embodiment, while the navigation control screen is being displayed as an image of content for the driver and this navigation control screen is being operated, an interrupt signal that indicates this information is sent from the navigation control unit 10 to the DVD/CD control unit 12. Upon receiving the interrupt signal indicating that the navigation control screen is being operated from the navigation control unit 10, the DVD/CD control unit 12 performs control so that a DVD/CD control screen currently being displayed is cleared (not displayed). Thus, as shown in FIG. 3, the DVD/CD control screen is not displayed while the navigation screen is being operated.

Additionally, in this embodiment, when important driving information is displayed as an image of the content for a driver, an interrupt signal indicating that information is sent from the navigation control unit 10 to the DVD/CD control unit 12. Upon receiving the interrupt signal indicating that the important driving information is displayed from the navigation control unit 10, the DVD/CD control unit 12 performs control so that a DVD/CD control screen currently being displayed is cleared. Thus, as shown in FIG. 4, the DVD/CD control screen is not displayed while important driving information is being displayed.

As noted above, according to the display apparatus 6 of this embodiment, the use of the content for a driver (a navigation image) by the operator sitting in the driver seat is not disturbed by the operation of a control screen of the touch panel 8 by the operator sitting in the front passenger seat when needed (i.e., when the operation required for driving is executed or when information required for driving is provided).

While the present invention has been described with reference to the exemplary embodiment, the invention is not limited thereto. Various modifications can be made as needed.

In the above-described embodiment, while the navigation control screen is being operated or important driving information is being displayed, the display of a DVD/CD image is controlled so that the DVD/CD control screen is inoperable. However, the present invention is not limited thereto. For example, the operator sitting in the driver seat may determine the time for which he requires the display and the operator may enter some operation. In response to this operation, the display of the DVD/CD control screen may be controlled so that that the DVD/CD control screen is inoperable. Thus, the intent of the operator sitting in the driver seat is better reflected so that the use of the content for the operator sitting in the driver seat is not disturbed by the operation of the control screen of the touch panel by the operator sitting in the front passenger seat.

In addition, in the above-described embodiment, the control to avoid the interruption of the use of the content for the driver by the operator sitting in the driver seat when the operator requires the content has been described. However, the present invention is not limited to this embodiment. For example, the present invention can be applied to avoid the interruption of the use of the content for the front passenger seat by the operator sitting in the front passenger seat by the operation of the touch panel by the operator sitting in the driver seat.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A display apparatus comprising:
a display unit for simultaneously displaying a plurality of images corresponding to different contents on a screen of the display unit, each image being viewable from a specific viewing direction when the screen is viewed from a plurality of different viewing directions, the plurality of images containing at least one image corresponding to content serving as a touch-panel control screen; and
a display control unit for controlling, in accordance with a priority of the image corresponding to particular contents, the display of the images of the other contents so that the operation of a touch-panel control screen for the other contents is disabled.

2. The display apparatus according to claim 1, wherein the display control unit controls the display of the images of the other contents so that the operation of the touch-panel control screen for the other contents is disabled while the touch-panel control screen for the particular contents is being operated.

3. The display apparatus according to claim 2, wherein, in order to disable the operation of the touch-panel control screen for the other contents, the display control unit controls the display of the images of the other contents so that the touch-panel control screen for the other contents is not displayed.

4. The display apparatus according to claim 2, wherein, in order to disable the operation of the touch-panel control screen for the other contents, the display control unit controls the display of the images of the other contents so that a warning message indicating that the touch-panel control screen for the other contents is inoperable is displayed.

5. The display apparatus according to claim 2, wherein, in order to disable the operation of the touch-panel control screen for the other contents, the display control unit controls the display of the images of the other contents so that the touch-panel control screen for the other contents is displayed in a light color.

6. The display apparatus according to claim 2, wherein, in order to disable the operation of the touch-panel control screen for the other contents, the display control unit controls the display of the images of the other contents so that a control screen that allows an input operation other than the operation of the touch-panel control screen is displayed.

7. The display apparatus according to claim 1, wherein the display control unit controls the display of the images of the other contents so that the operation of the touch-panel control screen for the other contents is disabled while important information is being displayed as an image of the particular contents.

8. The display apparatus according to claim 7, wherein, in order to disable the operation of the touch-panel control screen for the other contents, the display control unit controls the display of the images of the other contents so that a warning message indicating that the touch-panel control screen for the other contents is inoperable is displayed.

9. The display apparatus according to claim 1, wherein the display control unit controls the display of the images of the other contents so that the operation of the touch-panel control screen for the other contents is disabled while the touch-panel control screen for the particular contents is being operated or while important information is being displayed as an image of the particular contents.

10. The display apparatus according to claim 9, wherein, in order to disable the operation of the touch-panel control screen for the other contents, the display control unit controls the display of the images of the other contents so that the touch-panel control screen for the other contents is not displayed.

11. The display apparatus according to claim 9, wherein, in order to disable the operation of the touch-panel control screen for the other contents, the display control unit controls the display of the images of the other contents so that a warning message indicating that the touch-panel control screen for the other contents is inoperable is displayed.

12. The display apparatus according to claim 9, wherein, in order to disable the operation of the touch-panel control screen for the other contents, the display control unit controls the display of the images of the other contents so that the touch-panel control screen for the other contents is displayed in a light color.

13. The display apparatus according to claim 9, wherein, in order to disable the operation of the touch-panel control screen for the other contents, the display control unit controls the display of the images of the other contents so that a control screen that allows an input operation other than the operation of the touch-panel control screen is displayed.

14. A display apparatus comprising:
a display unit for simultaneously displaying a plurality of images corresponding to different contents on a screen of the display unit, each image being viewable from a specific viewing direction when the screen is viewed from a plurality of different viewing directions, the plurality of images containing at least one image corresponding to content serving as a touch-panel control screen; and
a display control unit for controlling, in accordance with a priority of the image corresponding to particular contents, the display of the images of the other contents so that the operation of a touch-panel control screen for the other contents is disabled;
wherein the particular contents is a content for an operator sitting in a driver seat and the other contents are contents for an operator sitting in a front passenger seat.

15. The display apparatus according to claim 14, wherein the touch-panel control screen of the content for the operator sitting in a driver seat is a navigation control screen.

16. The display apparatus according to claim 14, wherein information displayed as an image of the content for the operator sitting in a driver seat is important driving information.

17. The display apparatus according to claim 16, wherein the important driving information includes an enlarged image of an intersection.

18. The display apparatus according to claim 16, wherein the important driving information includes slow traffic information.

19. A display apparatus comprising:
a display unit for simultaneously displaying a plurality of images corresponding to different contents on a screen of the display unit, each image being viewable from a specific viewing direction when the screen is viewed from a plurality of different viewing directions, the plurality of images containing at least one image corresponding to content serving as a touch-panel control screen; and
a display control unit for controlling, in accordance with a priority of the image corresponding to particular contents, the display of the images of the other contents so that the operation of a touch-panel control screen for the other contents is disabled;
wherein an interrupt signal is supplied to the display control unit in accordance with the priority of the image of the particular contents, and wherein, in response to the interrupt signal, the display control unit controls the display of the images of the other contents so that the operation of the touch-panel control screen for the other contents is disabled.

20. The display apparatus according to claim 1, wherein the display control unit controls the display of the images of the other contents so that the operation of the touch-panel control screen for the other contents is disabled when receiving an input operation indicating that the image of the particular contents has the higher priority.
